(19) United States
(12) Patent Application Publication
(10) Pub. No.: US 2023/0285860 A1
(43) Pub. Date: Sep. 14, 2023

(54) VIRTUAL CHARACTER CONTROL METHOD AND APPARATUS, STORAGE MEDIUM AND ELECTRONIC DEVICE

(71) Applicant: TENCENT TECHNOLOGY (SHENZHEN) COMPANY LIMITED, Shenzhen (CN)

(72) Inventors: Dancheng ZOU, Shenzhen (CN); Meng QIU, Shenzhen (CN); Jingjing HE, Shenzhen (CN); Boyi LIU, Shenzhen (CN); Weijian CUI, Shenzhen (CN); Cong TIAN, Shenzhen (CN)

(21) Appl. No.: 18/321,875

(22) Filed: May 23, 2023

Related U.S. Application Data
(63) Continuation of application No. PCT/CN2022/109823, filed on Aug. 3, 2022.

(30) Foreign Application Priority Data
Sep. 9, 2021 (CN) 202111058357.1

(51) Int. Cl. A63F 13/56; A63F 13/2145; G06F 3/04845; G06F 3/0488

(52) U.S. Cl. CPC A63F 13/56; A63F 13/2145; G06F 3/04845; G06F 3/0488

(57) ABSTRACT

A virtual character control method includes: displaying a virtual character and a virtual controller in a virtual scene, the virtual controller being configured to manipulate the virtual character based on a user operation; controlling the virtual character to move in the virtual scene in response to an operation performed on the virtual controller; and controlling, in response to the virtual controller being dragged to a first area in the virtual scene and a target object existing within a range around the virtual character during a movement of the virtual character, the virtual character to perform a predetermined action associated with the target object.

### CROSS-REFERENCES TO RELATED APPLICATIONS

This application is a continuation application of PCT Patent Application No. PCT/CN2022/109823, entitled “VIRTUAL CHARACTER CONTROL METHOD AND APPARATUS, STORAGE MEDIUM, AND ELECTRONIC DEVICE” and filed on Aug. 3, 2022, which claims priority to Chinese Patent Application No. 202111058357.1, filed with the Chinese Patent Office on Sep. 9, 2021 and entitled “VIRTUAL CHARACTER CONTROL METHOD AND APPARATUS, STORAGE MEDIUM AND ELECTRONIC DEVICE”, the entire contents of both of which are incorporated herein by reference.

### FIELD OF THE TECHNOLOGY

The present disclosure relates to the field of computers, and in particular, to a virtual character control method and apparatus, a storage medium, and an electronic device.

### BACKGROUND OF THE DISCLOSURE

In related applications, a user often needs to control a virtual character to perform different actions. For example, there are a lot of obstacles such as bunkers and houses in a virtual scene. In the virtual scene, the user needs to control the virtual character to cross different types of obstacles. For example, the virtual character may be controlled to climb over a low wall, or directly climb over and enter the house from a window. This type of operations of climbing over obstacles is common in the virtual scene.

At present, when controlling the virtual character, the user needs to control a motion direction of the virtual character and execution of actions such as jumping through different controllers. For example, the left hand is required to control the motion direction of the virtual character through a joystick, and the right hand is required to control the virtual character to perform jumping actions to climb over obstacles by touching a virtual button.

### SUMMARY

Embodiments of the present disclosure provide a virtual character control method and apparatus, a storage medium, and an electronic device for at least solving the technical problem of low efficiency in performing control operations on virtual characters, avoiding wasting processing resources of terminal devices, and improving the processing efficiency of the terminal devices.

According to one aspect of the embodiments of the present disclosure, provided is a virtual character control method, executed by an electronic device, including: displaying a virtual character and a virtual controller in a virtual scene, the virtual controller being configured to manipulate the virtual character based on a user operation; controlling the virtual character to move in the virtual scene in response to an operation performed on the virtual controller; and controlling, in response to the virtual controller being dragged to a first area in the virtual scene and a target object existing within a range around the virtual character during a movement of the virtual character, the virtual character to perform a predetermined action associated with the target object.

According to another aspect of the embodiments of the present disclosure, also provided is a virtual character control apparatus, including: a display module, configured to display a virtual character and a virtual controller in a virtual scene, the virtual controller being configured to manipulate the virtual character based on a user operation; a first control module, configured to control the virtual character to move in the virtual scene in response to an operation performed on the virtual controller; and a second control module, configured to control, in response to the virtual controller being dragged to a first area in the virtual scene and a target object existing within a range around the virtual character during a movement of the virtual character, the virtual character to perform a predetermined action associated with the target object.

According to still another aspect of the embodiments of the present disclosure, also provided is a non-transitory computer readable storage medium, having a computer program stored therein. The computer program is configured to perform the virtual character control method when being run.

According to yet another aspect of the embodiments of the present disclosure, also provided is an electronic device, including at least one memory and at least one processor. The at least one memory stores a computer program, and the at least one processor is configured to perform the virtual character control method through the computer program.

### BRIEF DESCRIPTION OF THE DRAWINGS

The accompanying drawings described herein are provided for further understanding of the present disclosure, and constitute a part of the present disclosure. Exemplary embodiments of the present disclosure and descriptions thereof are intended to explain the present disclosure, and do not constitute any inappropriate limitation to the present disclosure. In the accompanying drawings:

FIG. 1 is a schematic diagram of an application environment of a virtual character control method according to an embodiment of the present disclosure.

FIG. 2 is a schematic flowchart of a virtual character control method according to an embodiment of the present disclosure.

FIG. 3 is a schematic diagram of a virtual scene according to some embodiments of the present disclosure.

FIG. 4 is a schematic diagram of another virtual scene according to some embodiments of the present disclosure.

FIG. 5 is a schematic diagram of yet another virtual scene according to some embodiments of the present disclosure.

FIG. 6A to FIG. 6C are schematic diagrams of a one-handed operation according to some embodiments of the present disclosure.

FIG. 7A to FIG. 7C are schematic diagrams of another one-handed operation according to some embodiments of the present disclosure.

FIG. 8 is a schematic diagram of obstacle detection according to some embodiments of the present disclosure.

FIG. 9 is a schematic diagram of a virtual scene according to some embodiments of the present disclosure.

FIG. 10 is a schematic diagram of a function setting interface according to some embodiments of the present disclosure.

FIG. 11 is a flowchart of a virtual character control method according to some embodiments of the present disclosure.

FIG. 12 is a schematic structural diagram of a virtual character control apparatus according to an embodiment of the present disclosure.

FIG. 13 is a schematic structural diagram of an electronic device according to an embodiment of the present disclosure.

### DESCRIPTION OF EMBODIMENTS

To make a person skilled in the art better understand the solutions of the present disclosure, the following clearly and completely describes the technical solutions in the embodiments of the present disclosure with reference to the accompanying drawings in the embodiments of the present disclosure. Apparently, the described embodiments are only some of the embodiments of the present disclosure rather than all the embodiments. All other embodiments obtained by a person of ordinary skill in the art based on the embodiments of the present disclosure without creative efforts shall fall within the protection scope of the present disclosure.

It is to be illustrated that in the specification, claims, and the foregoing accompanying drawings of the present disclosure, the terms “first”, “second”, and so on are intended to distinguish between similar objects rather than indicating a specific order or sequence. It is to be understood that such used data is interchangeable where appropriate so that the embodiments of the present disclosure described here can be implemented in an order other than those illustrated or described here. Moreover, the terms “include”, “contain” and any other variants mean to cover the non-exclusive inclusion, for example, a process, method, system, product, or device that includes a list of steps or units is not necessarily limited to those expressly listed steps or units, but may include other steps or units not expressly listed or inherent to such a process, method, system, product, or device.

In some scenes where the virtual character is controlled, the left hand is required to control the motion direction of the virtual character through a joystick, and the right hand is required to control the virtual character to perform jumping actions to climb over obstacles by touching a virtual button. It is cumbersome for a user to operate with the left and right hands, which is inconvenient for the user to control the virtual character, thus resulting in low efficiency for the user to control the virtual character in the game.

In addition, some users often trigger an in-situ jumping action when they are not aiming at the obstacle. In this case, the virtual character controlled by the user may perform the jumping action back and forth in situ, and cannot successfully climb over the obstacle. On the one hand, in the process of jumping back and forth, the virtual character may be attacked by the enemy and easily eliminated. On the other hand, the action of jumping back and forth in situ cannot climb over obstacles, resulting in invalid operations performed by the user multiple times, and there is a problem of wasteful operations. Multiple invalid operations also waste the processing resources of the terminal device and reduce the processing efficiency of the terminal device.

For the problem above, in the embodiments of the present disclosure, an operation instruction of controlling the virtual character to perform a predetermined action associated with a target object in the virtual scene is triggered by a virtual controller, and the virtual controller may also control a motion direction of the virtual character. By integrating the triggers of different operations into a virtual controller, it is possible to control the motion direction of the virtual character and execution of the predetermined actions with one hand, and the user can realize one-handed control, which is convenient for the user to control the virtual character and improves the efficiency of performing the control operation on the virtual character. Repeated control operations by the user may be avoided, thereby reducing invalid operations, so that the terminal device does not need to waste a large amount of processing resources to process these invalid operations, and improves the processing efficiency of the terminal device.

In addition, in response to that an operation instruction for instructing the virtual character to perform a predetermined action is obtained, the virtual character is not immediately controlled to perform the predetermined action, but whether a target object exists within a preset range around the virtual character is detected first. In response to the existence of a target object, the virtual character is controlled to perform the predetermined action associated with the target object, and in response to no target object existing, the virtual character continues to maintain the current moving state. In this way, the problem of operation waste caused by controlling the virtual character to perform the predetermined action associated with the target object in response to that no target object exists around the virtual character may be avoided. Therefore, the waste of processing resources of the terminal device is further avoided, and the processing efficiency of the terminal device is improved.

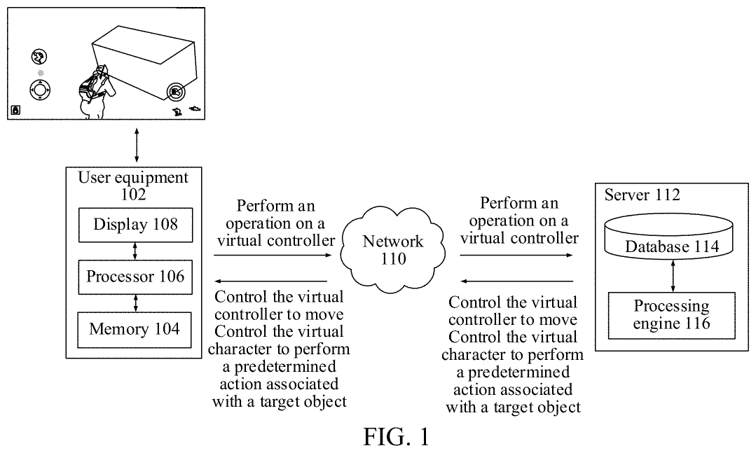

According to an aspect of the embodiments of the present disclosure, a virtual character control method is provided. As an implementation, the virtual character control method described above may but not limited to be applied to an environment as shown in FIG. 1. The system environment includes User Equipment (UE) 102, a network 110, and a server 112.

In some embodiments, the UE 102 includes: a memory 104, a processor 106, and a display 108. The memory is configured to store virtual scenes, virtual characters, target objects and the like in the applications. The processor is configured to process operation instructions, including but not limited to instructing the virtual character to perform a predetermined action associated with the target object, and controlling the motion direction of the virtual character. The display may be configured to display the virtual scenes, the virtual characters and the like. In this embodiment, the UE may be a UE configured with a target client, and may include but not limited to at least one of the following: mobile phones (such as an Android phone or an iOS phone), notebook computers, tablet computers, handheld computers, Mobile Internet Devices (MID), PADs, desktop computers, smart TVs, etc. The target client may be a video client, an instant messaging client, a browser client, an education client, etc. The network may include but is not limited to: a wired network and a wireless network. The wired network includes: a local area network, a metropolitan area network, and a wide area network. The wireless network includes: Bluetooth, WiFi, and other networks implementing wireless communication. The server may be a single server, or a server cluster composed of multiple servers, or a cloud server.

In some embodiments, the network 110 may include but is not limited to: a wired network and a wireless network. The wired network includes: a local area network, a metropolitan area network, and a wide area network. The wireless network includes: Bluetooth, WiFi, and other networks implementing wireless communication.

In some embodiments, the server 112 may be a single server, or a server cluster composed of multiple servers, or a cloud server. The server includes: a database 114 and a processing engine 116. The database is configured to store data, including but not limited to: virtual scenes, virtual characters, target objects and the like in the applications. The processing engine is configured to control the virtual character, including but not limited to controlling the virtual character to move in the character scene, and controlling the virtual character to perform a predetermined action associated with the target object. The foregoing is merely an example, which is not limited in this embodiment.

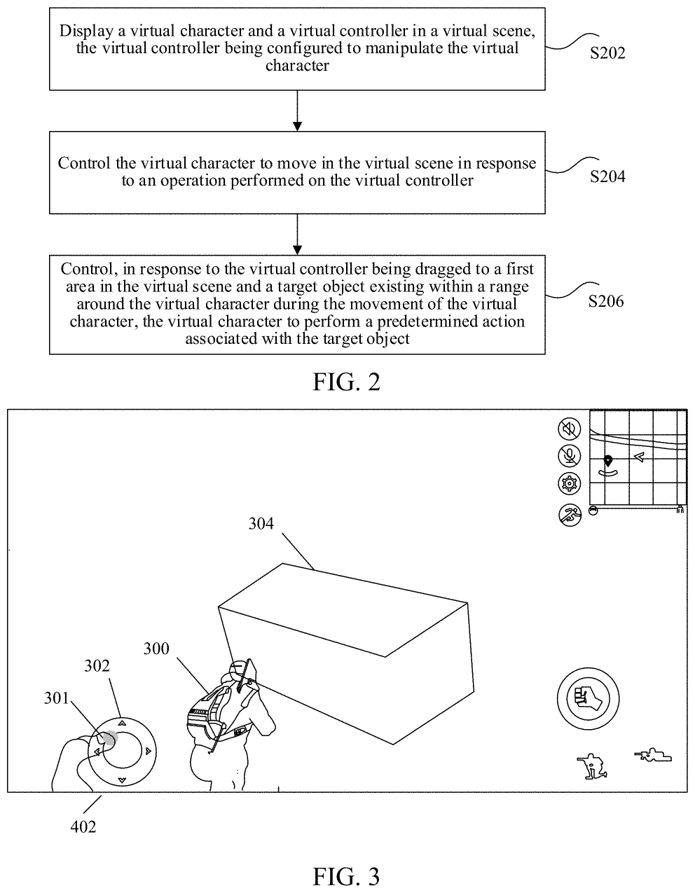

In some embodiments, as shown in FIG. 2, the virtual character control method may be applied to a target application, and includes the following steps:

Step S202: Display a virtual character and a virtual controller in a virtual scene, the virtual controller being configured to manipulate the virtual character.

The virtual scene is a scene in the target application, and the virtual character may be an object manipulated by a user in the virtual scene. The target application may be a game application, such as a shooting game application, a parkour game application, or other applications that have obstacle-crossing scenes, and the type of application is not limited here. In some embodiments, the virtual controller may be a virtual joystick, a virtual handle, a virtual button, and the like. The user may manipulate the virtual character through the virtual controller, including but not limited to controlling the virtual character to move in the virtual scene, and controlling the virtual character to perform the predetermined action associated with the target object in the target application.

Step S204: Control the virtual character to move in the virtual scene in response to an operation performed on the virtual controller.

The virtual controller may control the virtual character to move in the virtual scene, including but not limited to walking, running, and other moving modes, and may also control the moving direction of the virtual character, including but not limited to moving leftward, moving rightward, moving forward, and moving backward, etc.

Step S206: Control, in response to the virtual controller being dragged to a first area in the virtual scene and a target object existing within a range around the virtual character during the movement of the virtual character, the virtual character to perform a predetermined action associated with the target object.

The first area is an area displayed in the virtual scene of the target application. The user may set a size and a display position of the first area in advance. The first area may also be called a judgment area. In response to that the virtual controller is dragged to the judgment area, whether a target object exists within a preset range around the virtual character is detected, and in response to the existence of a target object, the virtual character is controlled to perform a predetermined action associated with the target object. The target object may be an obstacle in the virtual scene, and the predetermined action associated with the target object may be an action of climbing over an obstacle. The preset range may be set according to actual situations. For example, it is within a range of 5 meters or 10 meters from the virtual character. Taking the preset range being within 5 meters from the virtual character as an example, in response to an obstacle that may be crossed existing within 5 meters from the virtual character, the virtual character is controlled to perform an action of climbing over the obstacle.

Taking the preset range being within 5 meters from the virtual character as an example, in response to detecting that no target object that may perform a predetermined action exists within 5 meters from the virtual character, such as an obstacle that may be crossed, the virtual character is controlled to continue to maintain the current moving state in the game scene. For example, in response to the current moving state of the virtual character being running forward. In response to the virtual controller (such as a virtual joystick) being dragged to the judgment area and detecting that no target object associated with a predetermined action exists within the preset range, such as the obstacle that may be climbed over, the virtual character may continue to maintain the moving state of running forward.

In some embodiments, the controlling the virtual character to move in the virtual scene in response to an operation performed on the virtual controller includes: controlling, in response to an operation of dragging the virtual controller to a second area, a moving direction of the virtual character according to a position of the virtual controller in the second area.

As an implementation, the second area is an area for controlling the moving state of the virtual character. In response to the virtual controller being dragged to the second area, the moving direction of the virtual character may be controlled by the position of the virtual controller in the second area. FIG. 3 is a schematic diagram of a virtual scene according to some embodiments of the present disclosure. The embodiment as shown in FIG. 3 is described by taking the virtual controller being a virtual joystick and the target object being an obstacle as an example. FIG. 3 includes a virtual character 300 and an obstacle 304. The left part of FIG. 3 includes a virtual joystick 301 and a second area 302. The user may control the actions performed by the virtual character through the virtual joystick 301. For example, in response to that the virtual joystick 301 is located in the second area 302, the motion direction of the virtual character may be controlled. In response to the virtual joystick 301 being located at a position of a left arrow on the left of the second area, the virtual character is controlled to move leftward. In response to the virtual joystick 301 being located at a position of a right arrow on the left of the second are 302, the virtual character is controlled to move rightward.

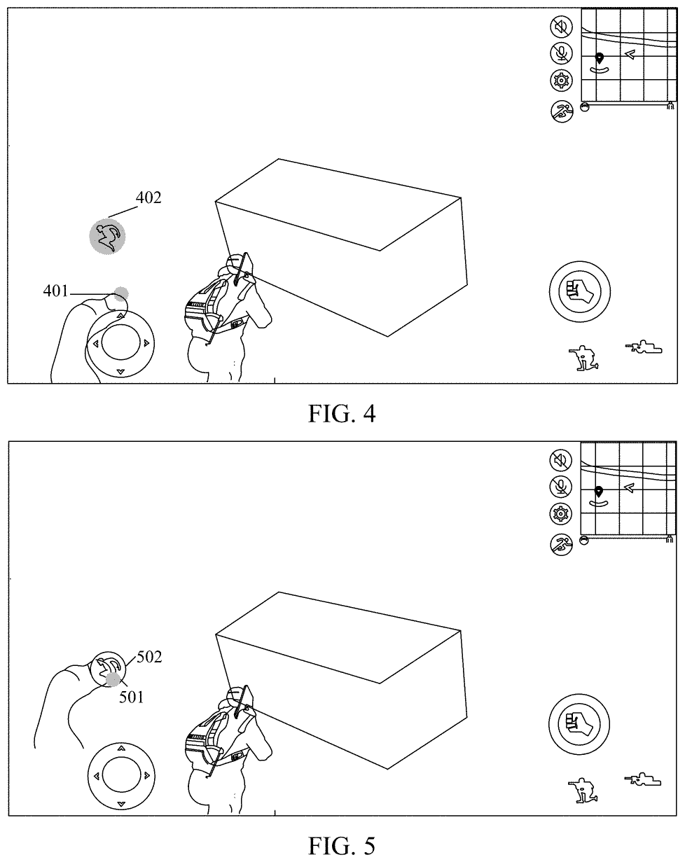

In response to that the virtual controller is touched to move out of the second area, the first area is displayed in the virtual scene. FIG. 4 is a schematic diagram of another virtual scene according to some embodiments of the present disclosure. The embodiment is still described by taking the virtual controller being a virtual joystick and the target object being an obstacle as an example. The user may control a position of a virtual joystick 401 in the virtual scene by dragging. As shown in FIG. 4, in a case of detecting that the virtual joystick 401 is dragged out of a second area, a first area 402 is displayed in the virtual scene to remind the user of the position of the first area. In response to the user continuing to drag the virtual joystick 401 to the first area 402, it is started to detect whether an obstacle exists within the preset range of the virtual character. As shown in FIG. 5, the user may continue to drag a virtual joystick 501 to a first area 502. In response to that the virtual joystick 501 is located in the first area 502, it is started to detect whether an obstacle exists within the preset range of the virtual character. In response to the existence of an obstacle, the virtual character is controlled to perform an action of climbing over the obstacle. In response to no obstacle existing, the virtual character is controlled to continue to perform the current moving state.

In the embodiments above, since the virtual controller may not only control the motion direction of the virtual character, but also control the virtual character to perform a predetermined action associated with the target object, the user may realize a one-handed operation. The efficiency of performing the control operation on the virtual character is improved. Repeated control operations by the user may be avoided, thereby reducing invalid operations, so that the terminal device does not need to waste a large amount of processing resources to process these invalid operations, and improves the processing efficiency of the terminal device.

In some embodiments, the method further includes: displaying the first area in response to that the virtual controller is dragged out of the second area; and obtaining an operation of dragging the virtual controller from the second area to the first area.

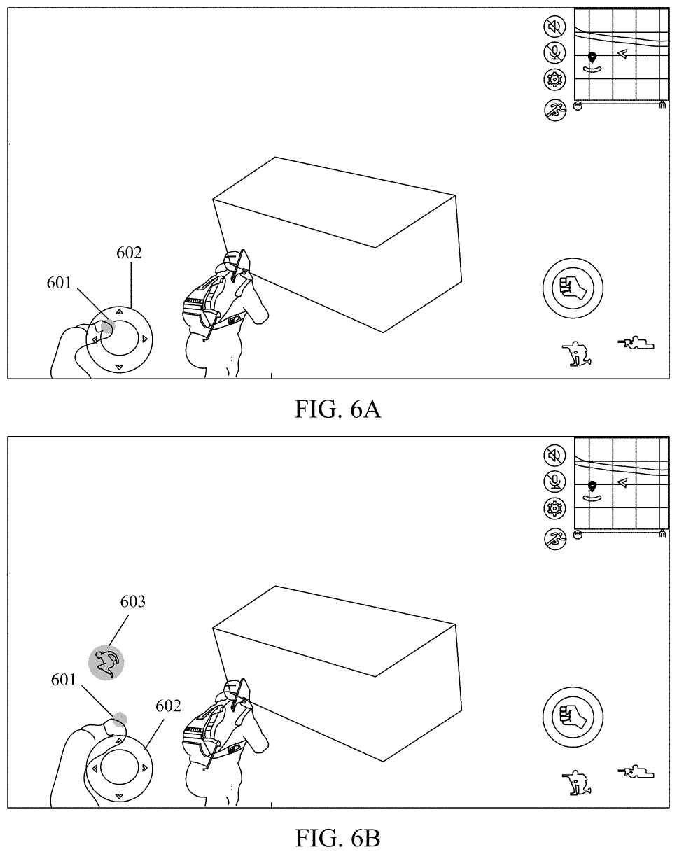

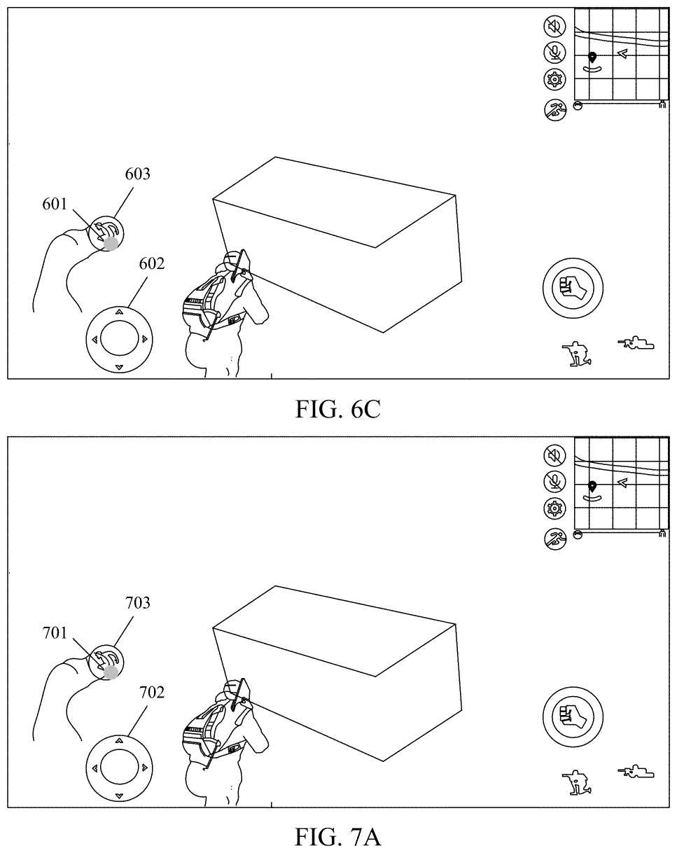

As an implementation, FIG. 6A to FIG. 6C are schematic diagrams of a one-handed operation according to some embodiments of the present disclosure. As shown in FIG. 6A, in response to that the user touches a virtual joystick 601 to slide to a second area 602, the moving direction of the virtual character may be controlled. As shown in FIG. 6B, in response to that the user drags the virtual joystick 601 out of the second area 602, a first area 603 is displayed in the virtual scene. As shown in FIG. 6C, in response to that the virtual controller is moved upwards on the Y-axis to the first area 603, it is started to determine whether a target object such as an obstacle exists in front of the virtual character controlled by the user in the current virtual scene. In response to determining that the target object exists, whether the target object is associated with a predetermined action, for example, whether the obstacle is an obstacle that may be climbed over is detected. In a case of determining that the target object is associated with a predetermined action, the virtual character controlled by the user starts to execute the predetermined action associated with the target object, for example, an action of climbing over an obstacle. In response to determining that the target object is not associated with a predetermined action, for example, the obstacle is an obstacle that cannot be climbed over, or no target object exists, the operation is determined to be invalid, and the virtual character controlled by the user may not perform an action associated with the target object, and continue to maintain the current moving state in the virtual scene. For example, in response to the virtual character being in a state of running forward before making a judgment, it may continue to maintain the motion of running forward, and continue to detect whether the virtual controller moves to the first area 603.

In this embodiment, in response to the virtual joystick 601 moving out of the second area 602, it is determined to be dragging. In this case, the first area 603 may be displayed, and an icon of the first area 603 may be lit. The first area 603 is a trigger area where the predetermined action associated with the target object is performed. As shown in FIG. 6B, in response to that the virtual joystick is dragged from the second area 602 to any position outside the second area 602, the first area 603 is displayed on the virtual scene. In this embodiment, in response to that the virtual joystick is located in the second area 602, the motion direction of the virtual character may be controlled. In this case, the first area 603 is not displayed in the virtual scene. In response to that the virtual joystick is dragged out of the second area 602, the first area 603 is displayed in the virtual scene. In this way, on the one hand, the problem that it is difficult for the user to distinguish different types of icons since multiple icons are displayed in the virtual scene may be avoided. On the other hand, in response to that the virtual joystick is dragged out of the second area 602, the first area 603 is displayed in the virtual scene, which may remind the user of the position of the first area 603, so that the user may control the virtual character to perform the action of climbing over the obstacle.

In some embodiments, after dragging the virtual controller from the second area to the first area, the method further includes: canceling display of the first area in response to that the virtual controller is dragged out of the first area.

As an implementation, in response to the user dragging the virtual controller to the first area, whether the virtual controller stays in the first area may be determined. In this case, in response to the virtual controller being dragged out of the first area, display of the first area may be canceled, that is, the icon of the first area is turned off. In this case, the virtual character controlled by the user continues to maintain the current moving state in the virtual scene. For example, the virtual character is in the state of running forward before making a judgment, then it may continue to keep running forward.

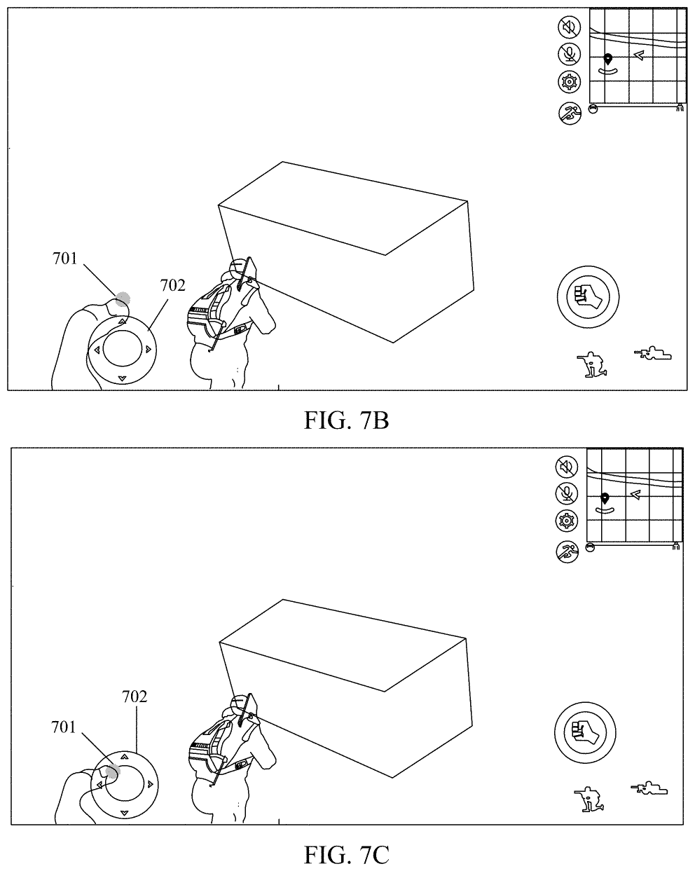

As an implementation, FIG. 7A to 7C are schematic diagrams of another one-handed operation according to some embodiments of the present disclosure. In response to that a virtual joystick 701 is dragged to a first area 703, it is started to determine whether a target object exists in front of the virtual character controlled by the user in the current virtual scene, and in response to determining that a target object exists, then whether the target object is associated with a predetermined action is determined. In response to determining that the target object is associated with a predetermined action (for example, the obstacle is an obstacle that may be climbed over), the virtual character controlled by the user starts to perform the predetermined action associated with the target object, such as an action of climbing over an obstacle. In response to determining that the target object is not associated with a predetermined action, for example, the obstacle is an obstacle that may not be climbed over, or no target object exists, the operation is determined to be invalid, and the virtual character controlled by the user may not perform the predetermined action associated with the target object, and continue to maintain the current moving state in the virtual scene. For example, in response to the virtual character being in the state of running forward before making a judgment, it may continue to maintain the action of running forward, and continue to detect whether the virtual controller moves to the first area. In response to the user continuing to drag the virtual controller out of the first area, display of the first area in the virtual scene is canceled. In response to that the user continues to drag the virtual controller to a second area 702, the moving direction of the virtual character may be controlled through a position of the virtual controller in the second area 702, such as moving forward, moving leftward, moving rightward, and moving backward.

In some embodiments, the method further includes: controlling, in response to the virtual controller being dragged to the first area and the target object not existing within a range around the virtual character during the movement of the virtual character, the virtual character to maintain a current moving state.

As an implementation, the certain range may be preset, e.g., 5 meters, 10 meters, 15 meters, etc. from the virtual character, and the specific preset range may be determined according to actual situations. The user may manipulate the virtual controller to move upward on the Y axis to the first area. In response to that the virtual controller moves to the first area, whether a target object exists within a preset range of the virtual character is determined. In response to existence of a target object, the virtual character is controlled to perform a predetermined action associated with the target object. In response to no target object existing, the virtual character is controlled to continue to execute the current moving state. For example, in response to the current moving state of the virtual character being running forward, the virtual character is controlled to continue running forward.

In some embodiments, the detecting whether the target object exists within the preset range around the virtual character in response to that the virtual controller is located in the first area includes: detecting whether the target object exists within the preset range around the virtual character in response to that a duration during which the virtual controller is located in the first area exceeds a first preset duration.

As an implementation, in response to the virtual controller being dragged to the first area, it is started to detect the duration during which the virtual controller is located in the first area. In response to a duration during which the virtual controller stays in the first area exceeding a preset duration, it is started to detect whether the target object exists within the preset range around the virtual character. The preset duration may be determined according to actual situation, for example, it may be 3 seconds, 4 seconds, 5 seconds, and so on.

Assuming that the user operates the virtual controller by touching a screen of a mobile phone, it is necessary to determine a duration during which the user's finger presses on the virtual controller. A long-press event of the user on the virtual controller needs to increase the long-press screen duration monitoring. The formula for calculating the duration of the long press on the screen is: the duration of the long press on the screen=a time point when the screen is released−a time point when the screen is pressed. Assuming that the first preset duration is set to 0.3 s, the time point when the user releases the screen is 18:30:400 milliseconds, and the time point when the screen is pressed is 18:30:0 milliseconds, then the duration of the long press on the screen is 18:30:400 milliseconds to 18:30:0 milliseconds, which is 400 milliseconds, corresponding to 0.4 seconds. In response to the long-press screen duration monitoring detecting that the time of long press of the user on the screen is 0.4 seconds, which exceeds the first preset duration 0.3 s, the duration monitoring judgment is passed, and it is started to determine whether a target object exists in front of the virtual character controlled by the user in the current virtual scene.

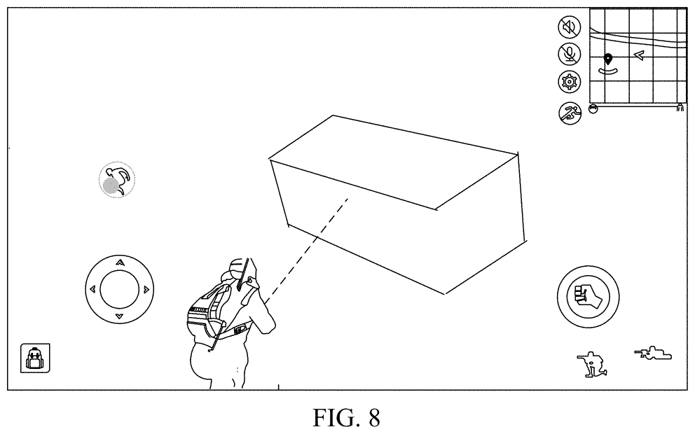

As an implementation, the virtual controller is dragged to the first area, and it is started to detect whether a target object exists within a preset range around the virtual character. The preset range may be determined according to actual situations. For example, in response to the current motion state of the virtual character being moving forward, the preset range may be a preset distance in front of the virtual character, such as 1 meter or 2 meters. FIG. 8 is a schematic diagram of detection of a target object according to some embodiments of the present disclosure. Assuming that the preset range is 1 meter in front of the virtual character, the virtual controller is dragged to the first area, the virtual character maintains the motion state of moving forward, and it is started to detect whether a target object exists within 1 meter in front of the virtual character. In response to no target object being detected, the virtual character is controlled to continue to move forward. In response to a target object being detected within 1 meter in front of the virtual character, the virtual character is controlled to perform a preset action associated with the target object. In this embodiment, in response to no target object existing within the preset range of the virtual character, the virtual character may continue to perform the current motion state, which prevents the virtual character from performing invalid actions in response to no preset object existing, avoiding the problem of too many invalid operations in the virtual scene.

In some embodiments, the method further includes: canceling, in response to the virtual controller moving out of the first area during controlling the virtual character to perform the predetermined action associated with the target object, control of the virtual character to perform the predetermined action, and controlling the virtual character to return to a position before performing the predetermined action.

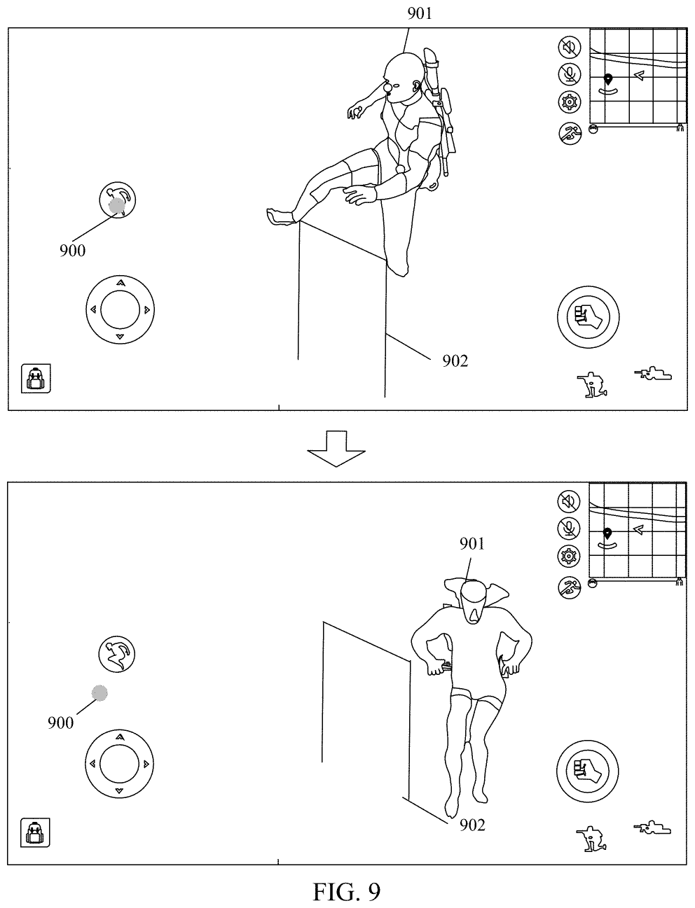

As an implementation, in response to that the virtual controller is dragged to the first area, it is started to detect whether a target object exists within the preset range, and in response to the existence of a target object, the virtual character is controlled to perform a predetermined action associated with the target object. In response to the virtual controller moving out of the first area in the process that the virtual character performs the predetermined action, the virtual character is canceled to perform the predetermined action, and the virtual character maintains the motion state before performing the predetermined action, or stays still around a virtual target object. FIG. 9 is a schematic diagram of yet another virtual scene according to some embodiments of the present disclosure. As shown in FIG. 9, in response to that a virtual controller 900 is in a first area, in response to detecting that a target object exists within a preset range around the virtual character 901, in this example, the target object shown is a virtual obstacle 902, and the virtual character 901 is controlled to perform an action of climbing over the obstacle 902. In the process that the virtual character performs the action of climbing over the obstacle 902, in response to the virtual controller 900 moving out of the first area, the virtual character 901 cancels the action of climbing over the obstacle 902.

In some embodiments, the method further includes: obtaining a setting instruction on a setting interface of the application; and setting, in response to the setting instruction, a size of the first area according to a size indicated by the setting instruction, and setting the first area at a position indicated by the setting instruction.

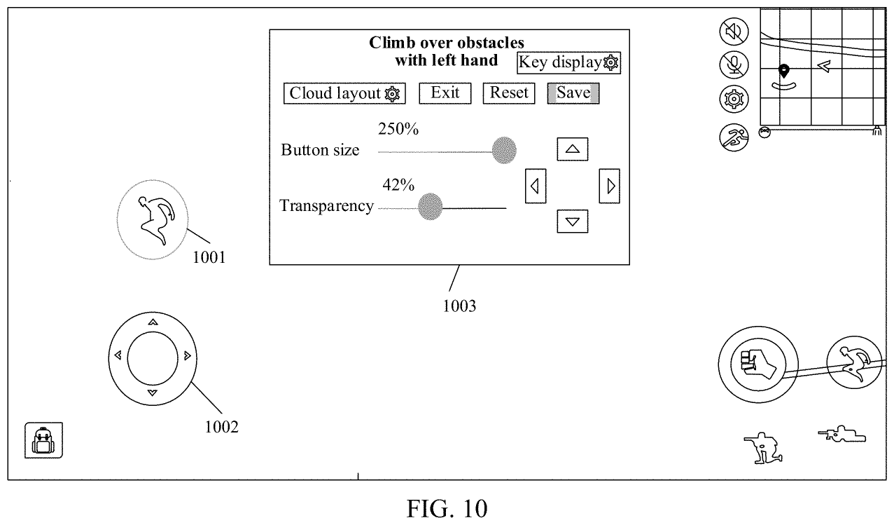

As an implementation, before the user drags the virtual controller to the first area to control the virtual character to perform the predetermined action associated with the target object, related parameters of the first area need to be preset. The user may select to use or cancel the use of this function as needed, and may operate the setting interface of the first area by saving and exiting a touch control. FIG. 10 is a schematic diagram of a function setting interface according to some embodiments of the present disclosure. A function interface of setting the first area is open in the setting system. The function interface includes a first area 1001 and a second area 1002. Dragging the first area 1001 and the second area 1002 may set the positions of the first area 1001 and the second area 1002 in the virtual scene. The function interface further includes a parameter setting area 1003 where parameters of a button of the first area 1001 such as the size and color may be set. After the parameters and position of the first area 1001 are set and saved, the functions set for the first area may be used in an application.

As an implementation, the application being a game application is taken as an example. The user may click to enter the setting interface in a lobby or game. In the setting interface, a setting function page of “Climb over obstacles with left hand” is open. After the setting function page of “Climb over obstacles with left hand” is open, the user may enter the operation setting of “Climb over obstacles with left hand”, adjust the specific size of the first area corresponding to “Climb over obstacles with left hand” on the Y axis, and adjust the specific position of the first area corresponding to “Climb over obstacles with left hand” on the Y axis. After the size and position of the first area corresponding to “Climb over obstacles with left hand” are adjusted, a touch control of the first area is clicked to save, and it may take effect in the game. The user may drag the position of the virtual controller in the game to achieve a one-handed (left-handed) operation to climb over obstacles. Moreover, during the climbing period, the user may manipulate the virtual controller with a finger to move out of the first area, to cancel the climbing action.

In some embodiments, the controlling a moving direction of the virtual character according to a position of the virtual controller in the second area includes: controlling the virtual character to move leftward in response to that the virtual controller is located at a left position in the second area; controlling the virtual character to move rightward in response to that the virtual controller is located at a right position in the second area; controlling the virtual character to move forward in response to that the virtual controller is located at an upper position in the second area; and controlling the virtual character to move backward in response to that the virtual controller is located at a lower position in the second area.

As an implementation, a plurality of direction arrow identifiers may be set at each direction position in the second area, and the identifiers are used for representing controlling the moving direction of the virtual character. For example, an upper arrow identifier is set above the second area, and in response to the virtual controller being dragged to the upper arrow identifier on an upper position of the second area, the virtual character may be controlled to move forward. In response to the virtual controller being dragged to a left arrow identifier on the left side of the second area, the virtual character may be controlled to move leftward. In response to the virtual controller being dragged to a right arrow identifier on the right side of the second area, the virtual character may be controlled to move rightward. In response to the virtual controller being dragged to a lower position of the second area, the virtual character may be controlled to move backward.

In some embodiments, the controlling the virtual character to perform a predetermined action associated with the target object includes: controlling the virtual character to perform an action corresponding to a type of the target object, so that the virtual character climbs from one side of the target object to the other side of the target object, where the action includes a jumping action or a climbing action.

As an implementation, the virtual character may be controlled to perform a preset action associated with the target object according to the type of the target object. The type of the target object includes but is not limited to a box, a wall, a house window, and the like. For a smaller box, an action corresponding to the type of the target object may be jumping, spanning, etc. For example, the virtual character may climb over the target object through jumping and spanning actions. For a higher target object, such as the wall and the house window, an action corresponding to the type of the target object may be climbing, etc. For example, the virtual character may perform the climbing action to climb over the target object, and the action of climbing over the target object is not limited. An action of making the virtual character climb over from one side of the target object to the other side of the target object is set according to actual scenes. In this embodiment, the action performed by the virtual character may be controlled according to the type of the target object. For a smaller target object, the virtual character may be controlled to perform simple climbing actions such as jumping, and for a larger obstacle, the virtual character may be controlled to perform difficult climbing actions such as climbing. In this way, the virtual character may be controlled to perform a corresponding climbing action according to the type of the target object, so that the virtual scene is more suitable for the actual scene and the user experience is improved.

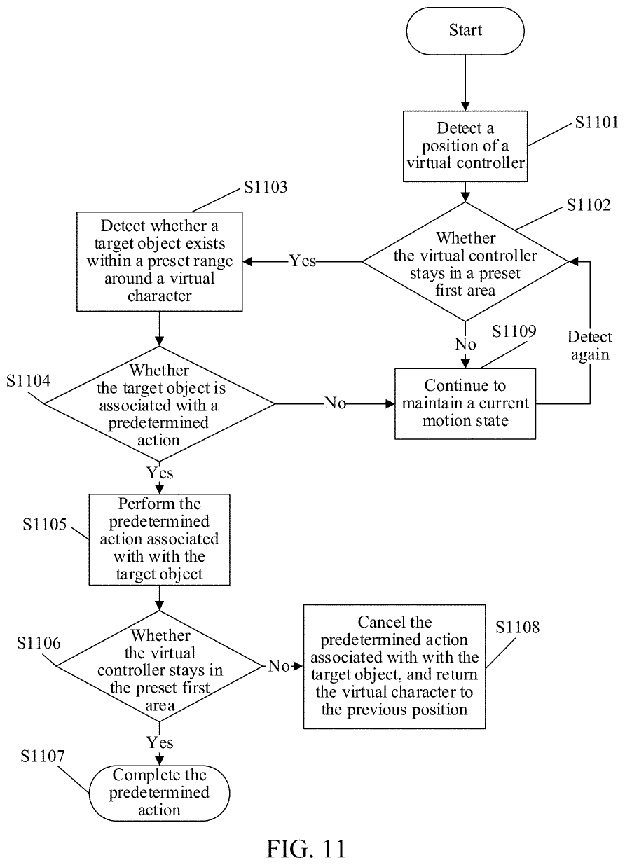

As an implementation, FIG. 11 is an overall schematic diagram according to some embodiments of the present disclosure, including the following steps:

Step S1101: Detect a position of a virtual controller in a virtual scene in the virtual scene. Specifically, the user may move the virtual controller to any position in the virtual scene by dragging the virtual controller, including but not limited to a first area, a second area, and any areas other than the first area and the second area.

Step S1102: Determine whether the virtual controller stays in the first area and a duration in the first area. In response to a duration during which the virtual controller stays in the first area exceeding a predetermined duration (which may be set arbitrarily, for example, 3 seconds), step S1103 is performed. In response to a duration during which the virtual controller stays in the first area being less than the predetermined duration, step S1109 is performed.

Step S1103: Detect whether a target object exists within a preset range around the virtual character, the preset range being determined according to actual situations. For example, within a preset distance from the virtual character, the preset distance may be 3 meters, 5 meters, etc., which may be set according to actual situations.

Step S1104: Determine, in response to detecting that a target object exists within the preset range around the virtual character, whether the target object may be climbed over; and in response to the target object being climbed over, perform step S1105, otherwise, perform step S1109.

Step S1105: Control the virtual character to perform an action of climbing over the target object such as jumping and climbing.

Step S1106: Continue to detect whether the virtual controller stays in the first area; in response to the virtual controller still staying in the first area, perform step S1107; and in response to the virtual controller not staying in the first area, perform step S1108.

Step S1107: Complete the climbing action of the virtual character, the virtual character climbing from one side of the target object to the other side.

Step S1108: Cancel the action of climbing over the target object, the virtual character returning to the position before climbing over the target object.

Step S1109: Continue to maintain the current motion state of the virtual character, and detect again whether the virtual controller stays in the preset first area.

It is to be illustrated that To simplify the description, the foregoing method embodiments are described as a series of action combination. However, a person skilled in the art knows that the present disclosure is not limited to any described sequence of actions, as some steps may adopt other sequences or may be executed simultaneously according to the present disclosure. In addition, a person skilled in the art also knows that all the embodiments described in the specification are preferred embodiments, and the related actions and modules are not necessarily mandatory to the present disclosure.

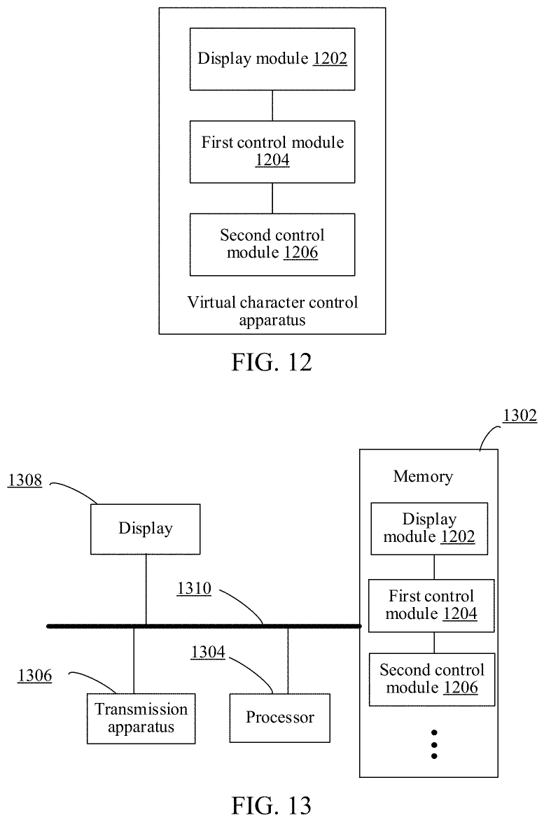

According to another aspect of the embodiments of the present disclosure, a virtual character control apparatus for implementing the virtual character control method is further provided. As shown in FIG. 12, the apparatus includes a display module 1202, a first control module 1204, and a second control module 1206. The display module 1202 is configured to display a virtual character and a virtual controller in a virtual scene, the virtual controller being configured to manipulate the virtual character. The first control module 1204 is configured to control the virtual character to move in the virtual scene in response to an operation performed on the virtual controller. The second control module 1206 is configured to control, in response to the virtual controller being dragged to a first area in the virtual scene and a target object existing within a certain range around the virtual character during the movement of the virtual character, the virtual character to perform a predetermined action associated with the target object.

In some embodiments, the apparatus is further configured to control, in response to an operation of dragging the virtual controller to a second area in the virtual scene, a moving direction of the virtual character according to a position of the virtual controller in the second area.

In some embodiments, the apparatus is further configured to display the first area in response to that the virtual controller is dragged out of the second area; and
obtain an operation of dragging the virtual controller from the second area to the first area.

In some embodiments, the apparatus is further configured to cancel, in response to the virtual controller being dragged out of the first area after the virtual controller is dragged to the first area in the virtual scene, display of the first area.

In some embodiments, the apparatus is further configured to control, in response to the virtual controller being dragged to the first area and the target object not existing within a certain range around the virtual character during the movement of the virtual character, the virtual character to maintain a current moving state.

In some embodiments, the apparatus is further configured to cancel, in response to the virtual controller moving out of the first area during controlling the virtual character to perform the predetermined action associated with the target object, control of the virtual character to perform the predetermined action associated with the target object, and control the virtual character to return to a position before performing the predetermined action.

In some embodiments, the apparatus is further configured to obtain a setting instruction on a setting interface; and
set, in response to the setting instruction, a size of the first area according to a size indicated by the setting instruction, and set the first area at a position indicated by the setting instruction.

In some embodiments, the apparatus is further configured to control the virtual character to move leftward in response to that the virtual controller is located at a left position in the second area; control the virtual character to move rightward in response to that the virtual controller is located at a right position in the second area; control the virtual character to move forward in response to that the virtual controller is located at an upper position in the second area; and control the virtual character to move backward in response to that the virtual controller is located at a lower position in the second area.

In some embodiments, the apparatus is further configured to control the virtual character to perform an action corresponding to a type of the target object, so that the virtual character climbs from one side of the target object to the other side of the target object, where the action includes a jumping action or a climbing action.

According to still another aspect of the embodiments of the present disclosure, an electronic device for implementing the virtual character control method is further provided. The electronic device may be a UE or server as shown in FIG. 1. This embodiment describes by taking the electronic device being a server as an example. As shown in FIG. 13, the electronic device includes a memory 1302 and a processor 1304. The memory 1302 stores a computer program, and the processor 1304 is configured to perform steps in any method embodiment through the computer program.

In some embodiments, the electronic device may be located in at least one of a plurality of network devices in a computer network.

In some embodiments, the processor may be configured to perform the following steps through the computer program:
displaying a virtual character and a virtual controller in a virtual scene, the virtual controller being configured to manipulate the virtual character;
controlling the virtual character to move in the virtual scene in response to an operation performed on the virtual controller; and
controlling, in response to the virtual controller being dragged to a first area in the virtual scene and a target object existing within a certain range around the virtual character during the movement of the virtual character, the virtual character to perform a predetermined action associated with the target object.

In some embodiments, a person of ordinary skill in the art may understand that, the structure as shown in FIG. 13 is only schematic. The electronic device may be a UE such as a mobile phone (such as an Android mobile phone or an iOS mobile phone), a tablet computer, a palmtop computer, a mobile Internet device (MID), or a PAD. FIG. 13 does not constitute a limitation on a structure of the electronic device. For example, the electronic device may further include more or less components (for example, a network interface) than those shown in FIG. 13, or has a configuration different from that shown in FIG. 13.

The memory 1302 may be configured to store a software program and module, for example, program instructions/modules corresponding to the virtual character control method and apparatus in the embodiments of the present disclosure. The processor 1304 runs the software program and module stored in the memory 1302, to implement various functional applications and data processing, that is, implement the foregoing virtual character control method. The memory 1302 may include a high-speed random memory, and may also include a non-volatile memory, for example, one or more magnetic storage apparatuses, a flash memory, or another non-volatile solid-state memory. In some embodiments, the memory 1302 may further include memories remotely disposed relative to the processor 1304, and the remote memories may be connected to a terminal through a network. Examples of the network include, but are not limited to, the Internet, an intranet, a local area network, a mobile communication network, and a combination thereof. The memory 1302 may specifically, but is not limited to, be used to store information such as game scenes, virtual characters, and obstacles in the target game application. As an example, as shown in FIG. 13, the memory 1302 may include, but is not limited to, a display module 1202, a first control module 1204, and a second control module 1206 in the virtual character control apparatus. In addition, it may also include but not limited to other module units in the virtual character control apparatus, which may not be repeated in this example.

In some embodiments, the transmission apparatus 1306 is configured to receive or send data via a network. Specific examples of the network include a wired network and a wireless network. In an example, the transmission apparatus 1306 includes a Network Interface Controller (NIC), which may be connected to another network device and a router through a network cable, so as to communicate with the Internet or the local area network. In an example, the transmission apparatus 1306 is a Radio Frequency (RF) module, which communicates with the Internet in a wireless manner.

In addition, the electronic device further includes a display 1308 and a connection bus 1310. The display 1308 is configured to display the game scenes, virtual characters, obstacles and the like. The connection bus 1310 is configured to connect module components in the electronic device.

In another embodiment, the terminal device or server may be a node in a distributed system. The distributed system may be a blockchain system which may be a distributed network formed by connecting the plurality of nodes in a network communication form. Nodes may form a Peer To Peer (P2P) network, and any form of computing devices, such as servers, terminals, and other electronic devices, may become a node in the blockchain system by joining the P2P network.

According an aspect of the present disclosure, provided is a computer program product or a computer program, including a computer instruction stored in a computer readable storage medium. A processor of a computer device reads the computer instruction from the computer readable storage medium. The processor executes the computer instruction so that the computer device executes the method provided in each implementation. The computer program is used for performing steps in any one of the foregoing method embodiments when being run.

In some embodiments, the computer readable storage medium may be configured to store a computer program used for performing the method steps of the foregoing embodiments.

In some embodiments, a person of ordinary skill in the art can understand that, all or some steps in the methods in the foregoing embodiments may be performed by a program instructing related hardware of a terminal device. The program may be stored in a computer readable storage medium. The storage medium may include: a flash drive, a Read-Only Memory (ROM), a Random Access Memory (RAM), a magnetic disk, an optical disk, and the like.

The sequence numbers of the foregoing embodiments of the present disclosure are merely for description purpose but do not imply the preference among the embodiments.

When the integrated unit in the foregoing embodiments is implemented in a form of a software functional unit and sold or used as an independent product, the integrated unit may be stored in the foregoing computer readable storage medium. Based on such an understanding, the technical solutions of the present disclosure essentially, or a part contributing to the related art, or all or a part of the technical solution may be implemented in a form of a software product. The computer software product is stored in a storage medium and includes several instructions for instructing one or more computer devices (which may be a personal computer, a server, a network device or the like) to perform all or some of steps of the methods in the embodiments of the present disclosure.

In the foregoing embodiments of the present disclosure, the descriptions of the embodiments have respective focuses. For a part that is not described in detail in an embodiment, refer to related descriptions in other embodiments.

In the several embodiments provided in the present disclosure, it is to be understood that the disclosed client may be implemented in another manner. The apparatus embodiments described above are merely exemplary. For example, the division of the units is merely the division of logic functions, and may use other division manners during actual implementation. For example, a plurality of units or components may be combined, or may be integrated into another system, or some features may be omitted or not performed. In addition, the coupling, or direct coupling, or communication connection between the displayed or discussed components may be the indirect coupling or communication connection through some interfaces, units, or modules, and may be electrical or of other forms.

The units described as separate components may or may not be physically separated, and the components displayed as units may or may not be physical units, and may be located in one place or may be distributed over a plurality of network units. Some or all of the units may be selected based on actual needs to achieve the objectives of the solutions of the embodiments of the disclosure.

In addition, functional units in the embodiments of the present disclosure may be integrated into one processing unit, or each of the units may be physically separated, or two or more units may be integrated into one unit. The integrated unit may be implemented in the form of hardware, or may be implemented in a form of a software functional unit.

The foregoing descriptions are merely some implementations of the present disclosure. A person of ordinary skill in the art may make several improvements and refinements without departing from the principle of the present disclosure, and the improvements and refinements shall fall within the protection scope of the present disclosure.

What is claimed is:

1. A virtual character control method, executed by an electronic device, comprising:
displaying a virtual character and a virtual controller in a virtual scene, the virtual controller being configured to manipulate the virtual character based on a user operation;
controlling the virtual character to move in the virtual scene in response to an operation performed on the virtual controller; and
controlling, in response to the virtual controller being dragged to a first area in the virtual scene and a target object existing within a range around the virtual character during a movement of the virtual character, the virtual character to perform a predetermined action associated with the target object.

2. The method according to claim 1, wherein the controlling the virtual character to move in the virtual scene in response to an operation performed on the virtual controller comprises:
controlling, in response to an operation of dragging the virtual controller to a second area in the virtual scene, a moving direction of the virtual character according to a position of the virtual controller in the second area.

3. The method according to claim 2, further comprising:
displaying the first area in response to that the virtual controller is dragged out of the second area; and
obtaining an operation of dragging the virtual controller from the second area to the first area.

4. The method according to claim 1, further comprising:
canceling display of the first area in response to the virtual controller being dragged out of the first area.

5. The method according to claim 1, further comprising:
controlling, in response to the virtual controller being dragged to the first area and the target object not existing within the range around the virtual character during the movement of the virtual character, the virtual character to maintain a current moving state.

6. The method according to claim 1, further comprising:
canceling, in response to the virtual controller moving out of the first area during controlling the virtual character to perform the predetermined action associated with the target object, control of the virtual character to perform the predetermined action associated with the target object, and controlling the virtual character to return to a position before performing the predetermined action.

7. The method according to claim 1, further comprising:
obtaining a setting instruction on a setting interface; and
setting, in response to the setting instruction, a size of the first area according to a size indicated by the setting instruction, and setting the first area at a position indicated by the setting instruction.

8. The method according to claim 2, wherein the controlling a moving direction of the virtual character according to a position of the virtual controller in the second area comprises:
controlling the virtual character to move leftward in response to that the virtual controller is located at a left position in the second area;
controlling the virtual character to move rightward in response to that the virtual controller is located at a right position in the second area;
controlling the virtual character to move forward in response to that the virtual controller is located at an upper position in the second area; and
controlling the virtual character to move backward in response to that the virtual controller is located at a lower position in the second area.

9. The method according to claim 1, wherein the controlling the virtual character to perform a predetermined action associated with the target object comprises:
controlling the virtual character to perform an action corresponding to a type of the target object, and to move from one side of the target object to the other side of the target object, wherein the action comprises a jumping action or a climbing action.

10. A virtual character control apparatus, comprising: at least one memory and at least one processor, the at least one memory storing a computer program, and the at least one processor being configured to execute the computer program and perform:
displaying a virtual character and a virtual controller in a virtual scene, the virtual controller being configured to manipulate the virtual character based on a user operation;
controlling the virtual character to move in the virtual scene in response to an operation performed on the virtual controller; and
controlling, in response to the virtual controller being dragged to a first area in the virtual scene and a target object existing within a range around the virtual character during a movement of the virtual character, the virtual character to perform a predetermined action associated with the target object.

11. The apparatus according to claim 10, wherein the controlling the virtual character to move in the virtual scene in response to an operation performed on the virtual controller comprises:
controlling, in response to an operation of dragging the virtual controller to a second area in the virtual scene, a moving direction of the virtual character according to a position of the virtual controller in the second area.

12. The apparatus according to claim 11, wherein the processor is further configured to perform:
displaying the first area in response to that the virtual controller is dragged out of the second area; and
obtaining an operation of dragging the virtual controller from the second area to the first area.

13. The apparatus according to claim 10, wherein the processor is further configured to perform:
canceling display of the first area in response to the virtual controller being dragged out of the first area.

14. The apparatus according to claim 10, wherein the processor is further configured to perform:
controlling, in response to the virtual controller being dragged to the first area and the target object not existing within the range around the virtual character during the movement of the virtual character, the virtual character to maintain a current moving state.

15. The apparatus according to claim 10, wherein the processor is further configured to perform:
canceling, in response to the virtual controller moving out of the first area during controlling the virtual character to perform the predetermined action associated with the target object, control of the virtual character to perform the predetermined action associated with the target object, and controlling the virtual character to return to a position before performing the predetermined action.

16. The apparatus according to claim 10, wherein the processor is further configured to perform:
obtaining a setting instruction on a setting interface; and
setting, in response to the setting instruction, a size of the first area according to a size indicated by the setting instruction, and setting the first area at a position indicated by the setting instruction.

17. The apparatus according to claim 11, wherein the controlling a moving direction of the virtual character according to a position of the virtual controller in the second area comprises:
controlling the virtual character to move leftward in response to that the virtual controller is located at a left position in the second area;
controlling the virtual character to move rightward in response to that the virtual controller is located at a right position in the second area;
controlling the virtual character to move forward in response to that the virtual controller is located at an upper position in the second area; and
controlling the virtual character to move backward in response to that the virtual controller is located at a lower position in the second area.

18. The apparatus according to claim 10, wherein the controlling the virtual character to perform a predetermined action associated with the target object comprises:
controlling the virtual character to perform an action corresponding to a type of the target object and to move from one side of the target object to the other side of the target object, wherein the action comprises a jumping action or a climbing action.

19. A non-transitory computer readable storage medium, comprising a stored program that causes, when run by at least one processor, the at least one processor to perform:
displaying a virtual character and a virtual controller in a virtual scene, the virtual controller being configured to manipulate the virtual character based on a user operation;
controlling the virtual character to move in the virtual scene in response to an operation performed on the virtual controller; and
controlling, in response to the virtual controller being dragged to a first area in the virtual scene and a target object existing within a range around the virtual character during a movement of the virtual character, the virtual character to perform a predetermined action associated with the target object.

20. The storage medium according to claim 19, wherein the controlling the virtual character to perform a predetermined action associated with the target object comprises:
controlling the virtual character to perform an action corresponding to a type of the target object and to move from one side of the target object to the other side of the target object, wherein the action comprises a jumping action or a climbing action.
